(19) United States
(12) Patent Application Publication
(10) Pub. No.: US 2026/0071964 A1
(43) Pub. Date: Mar. 12, 2026

(54) DETERMINATION APPARATUS AND CONTROL METHOD FOR DETERMINATION APPARATUS

(71) Applicant: CANON KABUSHIKI KAISHA, Tokyo (JP)

(72) Inventors: AKIRA TERAO, Kanagawa (JP); YUKI YONETANI, Kanagawa (JP); MAKOTO KAWAGUCHI, Kanagawa (JP)

(21) Appl. No.: 19/317,833

(22) Filed: Sep. 3, 2025

(30) Foreign Application Priority Data
Sep. 6, 2024 (JP) 2024-153714

(51) Int. Cl. G01N 21/65

(52) U.S. Cl. CPC G01N 21/65; G01N 2021/655; G01N 2201/06113

(57) ABSTRACT

A determination apparatus comprises an acquisition unit configured to acquire a Raman spectral image captured by an image capturing apparatus that captures stimulated Raman scattering light from a biological cell irradiated with excitation light, a generation unit configured to generate a spectral subtraction image of a pair of images corresponding to different wavenumber shift bands of the Raman spectral image, and a determination unit configured to determine a state of a cell based on the spectral subtraction image.

### BACKGROUND

### Field of the Technology

The present disclosure relates to a determination apparatus that determines a state of a cell and a method for controlling the determination apparatus.

### Description of the Related Art

A non-staining cell observation apparatus is known that observes a cell sample using a microspectroscopic observation method to identify a state of a cell without staining the cell. Examples of such a microspectroscopic observation techniques include Stimulated Raman scattering (SRS) microscopy.

SRS microscopy acquires a signal originated only from an imaginary part Imλ(3) of third-order nonlinear susceptibility λ(3) of a sample. SRS microscopy therefore reflects both a real part Reλ(3) and an imaginary part Imλ(3) of a stimulated Raman signal, and thus it is not affected by a non-resonance signal, and a level of a background signal originated from water present around a cell. In this respect, SRS microscopy is likely to ensure a contrast of a cell image with respect to a non-resonance signal reflecting both the real part and the imaginary part of the third-order nonlinear susceptibility λ(3).

There is a method for noninvasively evaluating a living sample using stimulated Raman scattering (SRS) light generated by such a nonlinear optical effect. An article published in the Journal of Physical Chemistry B. 2022, 126, 39:7595-7603 discusses a method of quantifying an intracellular density by separating signal loss caused by sample-induced aberration and light scattering in a multicellular sample by using an SRS signal ratio of protein-derived SRS signal normalized by water-derived SRS signal. According to the Journal of Physical Chemistry B. 2022, 126, 39:7595-7603 discusses that a state of a cell such as apoptosis is detected using a change in the quantified intracellular density.

The Journal of Physical Chemistry B. 2022, 126, 39:7595-7603 discusses an evaluation method in which a normalized mass density distribution of cells is acquired from a ratio IRatio of an amount of a component corresponding to a protein (CH group) to an amount of a component corresponding to water (OH group), and a state of a cell in a sample is evaluated. According to the Journal of Physical Chemistry B. 2022, 126, 39:7595-7603, the stimulated Raman scattering (SRS) microscopy is used to acquire and use a Raman spectrum of a cell by scanning wavelength of an irradiated laser. The Journal of Physical Chemistry B. 2022, 126, 39:7595-7603 discloses that the mass density indicates low and high values between a living cell and a dead cell by the evaluation method.

In contrast, the evaluation method for evaluating a state of a cell discussed in the Journal of Physical Chemistry B. 2022, 126, 39:7595-7603 uses an amount of component equivalent to water inside the cell, so that in a case of observing a cell in a liquid that contains water such as a cell culture solution, influence of the water component contained in the liquid is inevitable. According to the Journal of Physical Chemistry B. 2022, 126, 39:7595-7603, a dry mass for a cell that is subjected to an immobilization treatment on a glass preparation slide to eliminate the influence of the cell culture solution.

### SUMMARY

The present disclosure is directed to the provision of a determination apparatus that determines a state of a cell using a minimally invasive method with fewer limitations on a sample form in view of the above-described constraint.

According to an aspect of the present disclosure, a determination apparatus comprises an acquisition unit configured to acquire a Raman spectral image captured by an image capturing apparatus that captures stimulated Raman scattering light from a biological cell irradiated with coherent primary light, a generation unit configured to generate spectral difference information that emphasizes one of two components of a Raman scattering light pair corresponding to different wavenumber shift bands of the Raman spectral image with respect to the other, and a determination unit configured to determine a state of the cell based on the spectral difference information.

According to another aspect of the present disclosure, a method for controlling a determination apparatus comprises an acquisition unit configured to acquire a Raman spectral image, a generation unit configured to generate spectral difference information that emphasizes a Raman signal of a first component with respect to a Raman signal of a second component, a cell region identification unit configured to identify a cell region, and a determination unit configured to determine a state of a cell contained in a sample. The method comprises acquiring the Raman spectral image with respect to a spectroscopically imaged sample using the acquisition unit, generating spectral difference information that emphasizes a Raman signal corresponding to a protein with respect to a Raman signal corresponding to fat contained in the sample from the Raman spectral image using the generation unit, acquiring cell identification information that identifies a cell region in a field of view of the Raman spectral image using the cell region identification unit, and determining a state of the cell based on the spectral difference information and the cell identification information using the determination unit.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a determination apparatus according to a first exemplary embodiment.

FIG. 2 is a process chart illustrating a method for controlling the determination apparatus according to the first exemplary embodiment.

FIG. 3 illustrates a determination apparatus according to a second exemplary embodiment.

FIG. 4 is a process chart illustrating a method for controlling the determination apparatus according to a third exemplary embodiment.

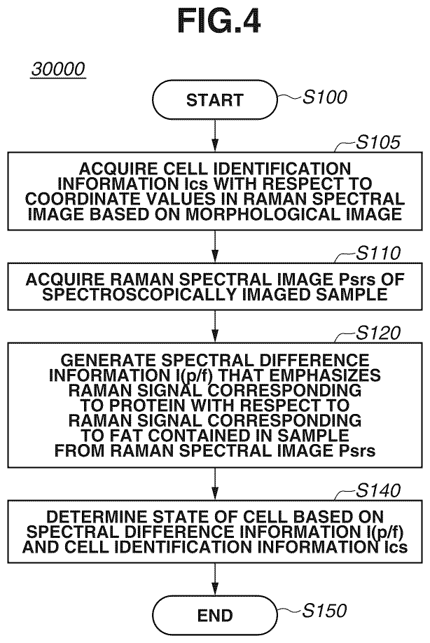

FIG. 5 illustrates a determination apparatus according to a fourth exemplary embodiment.

FIG. 6 is a process chart illustrating a method for controlling the determination apparatus according to the fourth exemplary embodiment.

### DESCRIPTION OF THE EMBODIMENTS

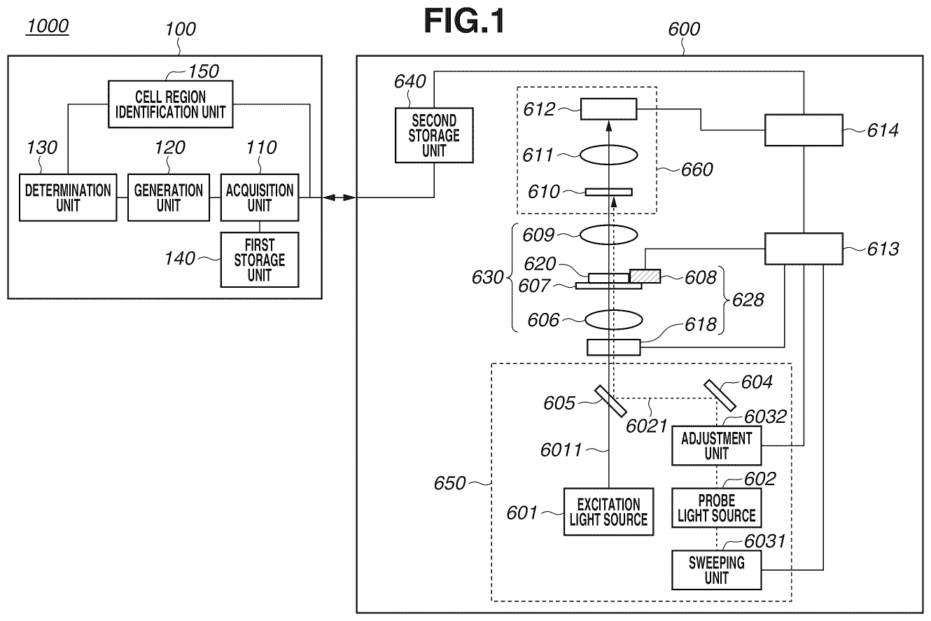

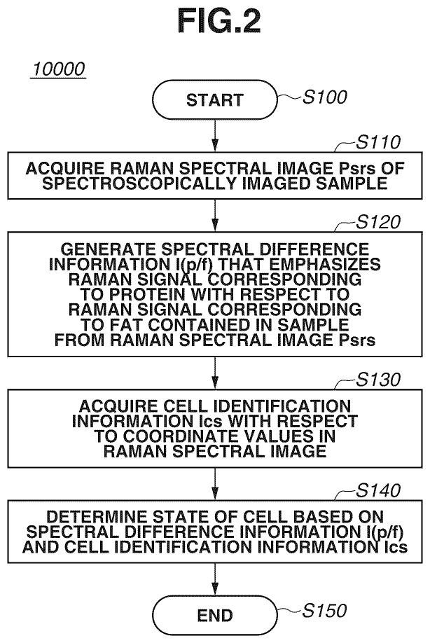

A determination apparatus 100 and a control method 10000 of the determination apparatus 100 according to a first exemplary embodiment will now be described with reference to FIGS. 1 and 2, and Tables 1, 2, and 3. FIG. 1 illustrates the determination apparatus 100 according to the first exemplary embodiment. FIG. 1 is also a drawing illustrating a determination system 1000 including the determination apparatus 100 that acquires a Raman spectral image from a stimulated Raman scattering (SRS) microscope 600 and determines a state of a cell contained in a sample. FIG. 2 is a process chart illustrating a method for controlling the determination apparatus 100 according to the first exemplary embodiment.

### (Determination System)

The determination system 1000 comprises the SRS microscope 600 and the determination apparatus 100 that acquires a Raman spectral image from the SRS microscope 600 and determines a state of a cell contained in a sample 620. The determination apparatus 100 according to the present exemplary embodiment is configured independently of the SRS microscope 600 to be able to perform signal processing or image processing for determining the state of the cell. The determination apparatus 100 can be modified to have a form in which the SRS microscope 600 is built in and a form in which a reconstruction unit 614 of the SRS microscope 600 described below is incorporated.

### (SRS Microscope)

The SRS microscope 600 applied to the determination apparatus 100 according to the present exemplary embodiment will now be described with reference to FIG. 1. The SRS microscope 600 is rephrased as an image capturing apparatus 600 that captures a Raman spectral image that can be output to the determination apparatus 100. The SRS microscope 600 comprises a placement unit 607 on which the sample 620 containing a biological cell is placed and a pair of objective lenses 630 (606 and 609) facing each other across the placement unit 607 so that at least a part of a focal spot fs overlaps with the sample 620. The SRS microscope 600 comprises an irradiation optical system 650 and a detection optical system 660. The irradiation optical system 650 irradiates the sample 620 with coherent primary light Ip through the objective lens 606. The detection optical system 660 detects a part of secondary light Is emitted from the sample 620 by a nonlinear optical effect via the objective lens 609. The pair of objective lenses 630 may be rephrased as the objective lens pair 630, and the objective lenses 606 and 609 may be respectively rephrased as one and the other of the pair of objective lenses 630.

### (Irradiation Optical System)

The irradiation optical system 650 comprises an excitation light source 601 that emits an excitation light pulse train 6011 and a probe light source 602 that emits a probe light pulse train 6021. The irradiation optical system 650 also comprises an adjustment unit 6032 that adjusts a time difference between one of the excitation light pulse train 6011 and the probe light pulse train 6021 and the other and a sweeping unit 6031 that sweeps a wavelength of the emitted coherent primary light Ip. The irradiation optical system 650 also comprises a mirror 604 and a multiplexing unit 605 to be optically coupled to the one objective lens 606 and to coaxially multiplex the excitation light pulse train 6011 and the probe light pulse train 6021. In multiplexing by the multiplexing unit 605, an optical path length of the probe light pulse train 6021 is adjusted using the adjustment unit 6032 such that the pulses of the excitation light pulse train 6011 and the probe light pulse train 6021 temporally coincide with each other.

The excitation light pulse train 6011 and the probe light pulse train 6021 are condensed into the sample 620 containing a culture solution and a living cell by the objective lens 606 for illumination. The secondary light Is including the excitation light pulse train 6011 and the probe light pulse train 6021, which pass through the sample 620 containing the culture solution and the cell and diverge, is converted into substantially parallel light by the objective lens 609 for focusing. Of the excitation light pulse train 6011 and the probe light pulse train 6021, the excitation light pulse train 6011 is selectively transmitted by an optical filter 610 and condensed by a condenser lens 611 on a photodetector (also referred to as detection unit) 612 in which light intensity of the excitation light pulse train 6011 is detected. The optical filter 610 can selectively transmit only the probe light pulse train 6021, and the probe light pulse train 6021 can be condensed by the condenser lens 611 on the photodetector 612, and light intensity of the probe light pulse train 6021 can be detected.

### (Detection Optical System)

The detection optical system 660 comprises the optical filter 610 that selectively transmits a wavelength component of the excitation light or the probe light from the secondary light Is collected through the other objective lens 609, and the condenser lens 611 that condenses transmitted light that is transmitted through the optical filter 610. The detection optical system 660 also comprises the detection unit 612 that detects a part of the secondary light Is guided through the optical filter 610 and the condenser lens 611 and outputs a detection signal.

Here, an output signal of the photodetector 612 is transmitted to a control unit 613. A scanning signal and a coordinate position of a stage scanning unit 608 are also transmitted to the control unit 613, and reconstructed as an image by the reconstruction unit 614 together with the output signal of the photodetector 612, thereby a Raman spectral image Psrs is acquired.

At this time, a wavelength of the probe light pulse train 6021 is swept at high speed from 1015 nm to 1030 nm, so that a spectral image is acquired in which Raman spectra are densely acquired in a range of 150 cm⁻¹ from 2800 cm⁻¹ to 2950 cm⁻¹ for each pixel of the image. To detect the output signal from the photodetector 612 with high sensitivity, it is also possible to perform lock-in detection using a pulse repetition frequency signal of the probe light pulse train 6021, which is not illustrated, as a reference input.

### (Scanning System)

The SRS microscope 600 comprises a scanning unit 628 that changes a relative position of the focal spot fs with respect to the sample 620. The scanning unit 628 comprises a stage scanning unit 608 that scans the placement unit 607 in a direction intersecting with an optical axis OA of the primary light Ip and an optical axis scanning unit 618 that scans the optical axis OA in the direction intersecting with the optical axis OA of the primary light Ip.

### (Control Unit)

The SRS microscope 600 comprises the control unit 613 that controls the scanning unit 628, the sweeping unit 6031, the excitation light source 601, and the probe light source 602 in cooperation with each other.

### (Reconstruction Unit)

The SRS microscope 600 comprises the reconstruction unit 614 that reconstructs an image based on a position of the focal spot fs and the detection signal detected by the detection unit 612 to generate the Raman spectral image. The reconstruction unit 614 may be rephrased as an imaging unit 614, an image generation unit 614, and an image forming unit 614 in some cases.

### (Excitation Light Source)

The excitation light source 601 is arranged to emit the excitation light pulse train 6011 toward the multiplexing unit 605. The excitation light pulse train 6011 is desirably short pulse light having a short pulse width to efficiently generate a nonlinear optical effect in a sample, and the pulse width is desirably on an order of femtoseconds to picoseconds. Further, repetition frequency of the pulse train is desirably 1 MHs or more from a viewpoint of mitigating influence of intensity fluctuation of the excitation light pulse train 6011.

As the excitation light source 601, a titanium sapphire laser is adopted that oscillates in a near-infrared band to satisfy the pulse width and the repetition frequency of the excitation light pulse train 6011. In a case where a titanium sapphire laser is adopted as the excitation light source 601, the wavelength of the excitation light is set between 700 nm (nanometers) and 1000 nm.

### (Probe Light Source)

The probe light source 602 is arranged to emit the probe light pulse train 6021 toward the sweeping unit 6031 or the adjustment unit 6032 that adjusts a delay time. As with the excitation light source 601, a pulsed light source that emits the probe light pulse train 6021 that is a short pulse train is adopted as the probe light source 602. Further, a pulse width of the probe light pulse train 6021 is on the order of femtoseconds to picoseconds. The probe light source 602 can be an optical fiber laser, such as an ytterbium (Yb) fiber laser or an erbium (Er) fiber laser. The pulse repetition frequency of the probe light pulse train 6021 is also configured to be half of the pulse repetition frequency of the excitation light pulse train 6011. This configuration can modulate the excitation light pulse train 6011 and the probe light pulse train 6021 at the same pulse repetition frequency as the probe light pulse train 6021 by the nonlinear optical effect of the sample. The probe light pulse train 6021 passes through an optical delay system and is swept between the wavelengths of 1015 nm and 1030 nm in the sweeping unit 6031.

The wavelength of the probe light pulse train 6021 is set according to a type of a cell sample serving as a target of state determination and the wavelength of the excitation light pulse train 6011. In other words, a wavelength that is different from the wavelength of the excitation light pulse train 6011 by about a wavelength corresponding to a Raman shift (wavenumber shift) of molecule information to be detected is adopted to the wavelength of the probe light pulse train 6021. For example, the excitation light source 601 and the probe light source 602 are configured such that the Raman spectrum with a wavenumber of 2800 cm⁻¹ or more and 2950 cm⁻¹ or less can be acquired as the Raman shift for acquiring information about a protein and fat. A wavenumber shift band corresponding to fat is included in a wavenumber shift band of 2800 cm⁻¹ or more and 2900 cm⁻¹ or less, and a wavenumber shift band corresponding to a protein is included in a wavenumber shift band of 2920 cm⁻¹ or more and 2940 cm⁻¹ or less. In a form in which a titanium sapphire laser is adopted as the excitation light source 601 and the wavelength of the excitation light pulse train 6011 is 790 nm, the wavelength of the probe light pulse train 6021 from the probe light source 602 controlled by the sweeping unit 6031 is swept between 1015 nm and 1030 nm.

### (Determination Apparatus)

Next, the determination apparatus 100 that determines a state of a cell based on a Raman spectral image captured by the SRS microscope 600 according to the present exemplary embodiment will be described with reference to FIG. 1.

The determination apparatus 100 comprises an image acquisition unit 110 that acquires a Raman spectral image Imr captured by the image capturing apparatus 600 that captures a stimulated Raman scattering light from a biological cell irradiated with excitation light. The determination apparatus 100 also comprises a generation unit 120 that generates spectral difference information Ifd emphasizing a Raman scattering light signal Sot with respect to a Raman scattering light signal Son, where the Raman scattering light signals Son and Sot respectively correspond to one and the other of the different wavenumber shift bands of the Raman spectral image Imr. The determination apparatus 100 also comprises a cell region identification unit 150 that acquires cell identification information Ifc that identifies a cell region in a field of view FOV of the Raman spectral image Imr and a determination unit 130 that determines a state of a cell based on the spectral difference information Ifd and the cell identification information Ifc.

### (Determination Unit)

The determination unit 130 determines the state of the cell based on a result of comparing a predetermined reference value with the spectral difference information.

### (Spectral Difference Information)

The spectral difference information Ifd comprises information Ifad about coordinate values in the field of view FOV and difference value information Ifdv corresponding to a difference value between one Raman scattering light signal Ione and the other Raman scattering light signal lote. The different wavenumber shift bands correspond to the wavenumber shift band corresponding to a protein and the wavenumber shift band corresponding to fat, which do not overlap with each other.

### (Method for Controlling Determination Apparatus)

A state of a cell can be determined by executing a method for controlling the determination apparatus 100 according to the present exemplary embodiment. The control method 10000 of the determination apparatus 100 for determining the state of the cell will now be described with reference to FIG. 2.

The determination apparatus 100 to be a control target of The control method 10000 comprises, as illustrated in FIG. 1, the acquisition unit 110 that acquires a Raman spectral image and the generation unit 120 that generates the spectral difference information that emphasizes a Raman signal of a first component with respect to a Raman signal of a second component. The determination apparatus 100 serving as the target of the control method 10000 comprises the determination unit 130 that determines the state of the cell contained in the sample based on the spectral difference information as illustrated in FIG. 1.

### (Step S110 for Acquiring Raman Spectral Image)

The control method 10000 comprises step S110, which is executed using the acquisition unit 110, for acquiring the Raman spectral image Psrs of the sample 620 that is spectroscopically imaged as illustrated in FIG. 2.

The Raman spectral image Psrs acquired in the present step is the image reconstructed by the reconstruction unit 614, is transmitted from the SRS microscope 600 to the determination apparatus 100, and passed to a next step, step S120, for generating the spectral difference information. The Raman spectral image Psrs formed as an image by the reconstruction unit 614 is stored in a second storage unit 640 and transmitted to the acquisition unit 110 of the determination apparatus 100 based on a predetermined read command. The predetermined read command is issued to the second storage unit 640 by the acquisition unit 110, the control unit 613, and the like.

Here, a data format of the Raman spectral image Psrs acquired by the SRS microscope 600 will be described. As indicated in Table 1, the data format of the Raman spectral image Psrs comprises a plurality of Raman spectral signals Isrs with different wavenumber shift values for coordinate values (x, y, z).

As indicated in Table 1, the data format of the Raman spectral image Psrs sometimes comprises, as incidental information, imaging date and time (scanning time and acquisition time of the SRS Raman signal), sample information, and other incidental information.

Table 1 indicates an example of a data set of the Raman spectral image Psrs acquired in step S110.

Such data set is readably stored in a first storage unit 140.

In Table 1, spot numbers corresponding to an order of scanning positions of the excitation light pulse train 6011 and the probe light pulse train 6021 of the SRS microscope 600 are sorted in ascending order with a first priority, and a wavenumber shift Ak is sorted in ascending order with a second priority. When considering a case where Table 1 is sorted in ascending order with the wavenumber shift Ak as the first priority and the scan number as the second priority, it is clear that the Raman spectral image Psrs is rephrased as to be formed with a spectroscopic image set of a plurality of Raman spectral images psrs with different wavenumber shift values.

TABLE 1

| | Coordinate | Coordinate | Coordinate | Wavenumber | Signal | Date | | |
|---|---|---|---|---|---|---|---|---|
| Scan. | value | value | value | shift | intensity | and | Sample | Incidental |
| No | x | y | z | Δk/cm⁻¹ | Isrs/counts | time | information | information |
| 1 | 1 | 1 | 0 | 3150 | 4.5E−6 | #### | #### | **** |
| 2 | 1 | 1 | 0 | 3145 | 4.5E−6 | #### | #### | **** |
| 3 | 1 | 1 | 0 | 3140 | 4.6E−6 | #### | #### | **** |
| | M | N | | | | | | |

(Step S120 for Generating Spectral Difference Information)

The control method 10000 comprises step S120, which is executed using the generation unit 120, for generating spectral difference information I(p/f) for each coordinate value from the Raman spectral image Psrs acquired via the acquisition unit 110.

The spectral difference information I(p/f) is a signal that emphasizes a Raman signal Ip corresponding to the protein with respect to a Raman signal If corresponding to the fat contained in the sample 620. As the spectral difference information I(p/f) acquired in the present step, for example, a signal is adopted that is obtained by dividing the Raman signal Ip corresponding to a concentration of the protein by the Raman signal If corresponding to a concentration of the fat.

Table 2 indicates an example of a data set including the spectral difference information I(p/f) acquired in step S120. Such data set comprises at least the coordinate values and the spectral difference information I(p/f) and is readably stored in the first storage unit 140.

TABLE 2

| | | | | I(f)srs | I(p)srs | | |
|---|---|---|---|---|---|---|---|
| | | | | average | average | | |
| Spectral | | | | Δk | Δk | | |
| difference | Coordinate | Coordinate | Coordinate | band | band | Information | |
| information | value | value | value | 2800-2900 | 2920-2940 | about | Incidental |
| I(p/f) | x | y | z | (cm⁻¹) | (cm⁻¹) | sample | information |
| 0.11 | 1 | 1 | 0 | 123.5 | 13.1 | #### | **** |
| 2.1 | 115 | 340 | 0 | 140.1 | 294.2 | | |
| 1.7 | 115 | 341 | 0 | 136.0 | 231.4 | | |
| 0.13 | M | N | | 126.8 | 16.5 | | |

(Step S130 for Acquiring Cell Identification Information with respect to Coordinate Values in Raman Spectral Image)

The control method 10000 comprises step S130, which is executed using the cell region identification unit 150, for acquiring cell identification information Ics with respect to the coordinate values in the Raman spectral image. The present step S130 comprises a region determination step S130a for acquiring an outer contour of a cell of interest, which serves as a criterion for determining whether the coordinate values forming the Raman spectral image Psrs are inside or outside a predetermined cell. The present step S130 also comprises a region identification step S130b for assigning a unique cell identification code CN for corresponding to the cell region determined in step S130a in the field of view FOV. In the present step S130, the cell region and the cell identification code are used that have been determined based on the Raman spectral image Psrs, the Raman spectral image psrs corresponding to a specific wavenumber shift, a morphological image (not illustrated), and the like. The cell identification information Ics can be rephrased that it comprises information about a contour of the cell region and the cell identification code CN.

Table 3 indicates an example of a data set including the cell identification code CN acquired in step S130. The data set including the cell identification information Ics comprises at least the coordinate values and the cell identification information Ics, and is readably stored in the first storage unit 140.

TABLE 3

| Cell | | | |
|---|---|---|---|
| identification | Coordinate | Coordinate | Coordinate |
| code | value | value | value |
| CN | x | y | z |
| — | 1 | 1 | 0 |
| 1 | 2 | 1 | 0 |
| 1 | 3 | 1 | |
| . . . | . . . | 1 | |
| — | 57 | 1 | |
| 2 | 58 | 1 | |
| — | M | N | 0 |

(Step S140 for Determining State of Cell Based on Spectral Difference Information and Cell Identification Information)

The control method 10000 comprises step S140, which is executed using the determination unit 130, for determining the state of the cell based on the spectral difference information I(p/f) and the cell identification information Ics.

In the present step S140, the state of the cell is determined for each cell region having the common identification code CN by using the coordinate values having the common identification code CN acquired in step S130 and spectral difference information I (p/f) values corresponding to the coordinate values acquired in step S120. In the present step S140, the state of the cell in the cell region having the common identification code CN is determined by using an average spectral difference information Iave(p/f) value obtained by averaging the spectral difference information I(p/f) corresponding to the coordinate values having the common identification code CN.

Table 4 indicates an example of a data set including the coordinate values, the cell identification code CN, and the spectral difference information I(p/f) that are acquired in step S140. Similarly, Table 5 indicates an example of a data set including the cell identification code CN, the average spectral difference information Iave(p/f), and a determination result that are acquired in step S140. The respective data sets described in Tables 4 and 5 are readably stored in the first storage unit 140.

TABLE 4

| Cell | | | | | | |
|---|---|---|---|---|---|---|
| identification | Coordinate | Coordinate | Coordinate | | Information | |
| code | value | value | value | | about | Incidental |
| CN | x | y | z | I(p/f)srs | sample | information |
| — | 1 | 1 | 0 | | #### | **** |
| 1 | 2 | 1 | 0 | 0.90 | | |
| 1 | 3 | 1 | 0 | 0.78 | | |
| . . . | . . . | 1 | 0 | | | |
| — | 57 | 1 | 0 | | | |
| 2 | 58 | 1 | 0 | 0.46 | | |
| — | M | N | 0 | | | |

TABLE 5

| Cell | | | | |
|---|---|---|---|---|
| identification | | | Information | |
| code | | | about | Incidental |
| CN | Iave(p/f)srs | Determination | sample | information |
| 1 | 0.91 | Living | | |
| 2 | 0.37 | Dead | | |
| 3 | 0.55 | Boundary | | |
| 4 | 0.87 | Living | | Partial |
| 5 | 0.18 | Dead | | Partial |

The present step S140 is performed only on the coordinate values in the cell of interest based on the cell identification information Ics, thereby making it possible to reduce a calculation load of determining the state of the cell and a decrease in throughput of determination processing.

In a case where the average spectral difference information Iave(p/f) value is a predetermined lower limit threshold value Ith(p/f) or more, the cell of interest is determined as a living cell. The lower limit threshold value Ith(p/f) is desirably calibrated for each type of the cell of interest and is set to be 0.4 or more and 0.8 or less. The lower limit threshold value serving as the criterion for determining the state of the cell adopted in the data set indicated in Table 5 is set to have two stages. The state of the cell comprises at least one of activity, live or dead state, cause of death, and pharmacological effect of the cell. A first lower limit threshold value Ith1(p/f) for determining that the state of the cell is normal (a living cell) and a second lower limit threshold value Ith2(p/f) for determining that the state of the cell is not yet dead cell but is in a boundary state in which a probability of the cell being a living cell is low are set. According to the present exemplary embodiment, the first lower limit threshold value Ith1(p/f) and the second lower limit threshold value Ith2(p/f) are respectively set to 0.67 and 0.50. The predetermined lower limit threshold value Ith(p/f) can be set in three or more stages.

The data set in Table 5 comprises, in a column of the incidental information, the incidental information that explicitly indicates that the cell is a partial cell with respect to a partial cell region that is cut off from the field of view FOV with respect to the cell region present in the field of view FOV and the region extracted cell identification code CN. The partial cell region and an entire cell region in which the entire cell region is included in the field of view FOV can thereby be distinguished in determination by a user or the determination apparatus 100.

A determination apparatus 200 according to a second exemplary embodiment is a determination apparatus that determines a state of a cell in a sample using a Raman spectral image from the SRS microscope 600 and a storage device 305. The determination apparatus 200 is different from the determination apparatus 100 according to the first exemplary embodiment in that the SRS microscope 600, the storage device 305, a central processing unit (CPU) 501, a random access memory (RAM) 502, an input/output interface 504, and the like are connected via an Internet line 503 (network).

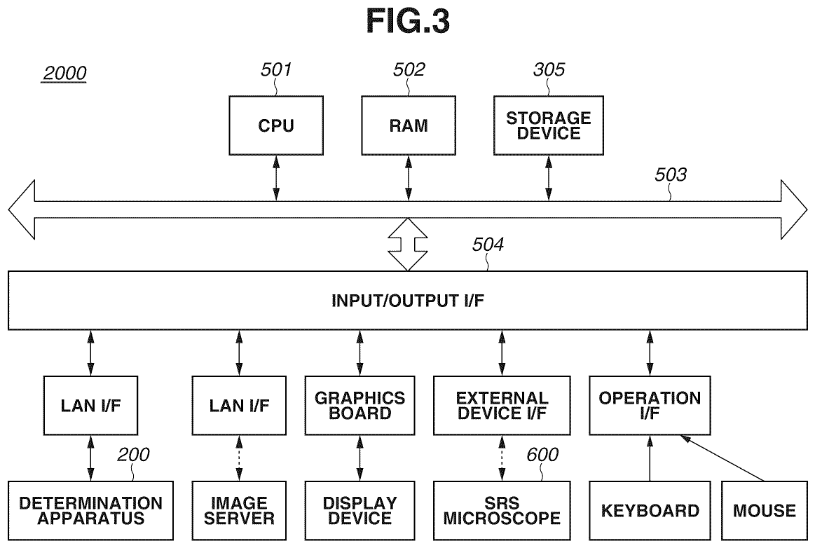

FIG. 3 illustrates a schematic configuration of a determination system 2000 according to the present exemplary embodiment. The determination apparatus 200 configures the determination system 2000 that determines a state of a cell together with the SRS microscope 600. The determination apparatus 200 is configured to be able to mutually access the storage device 305 that stores a plurality of Raman spectral images captured by a plurality of the SRS microscopes 600, so that statistical certainty of a basis for determination is improved more than that of the determination apparatus 100.

A control method 30000 for a determination apparatus according to a third exemplary embodiment is different from the control method 10000 for the determination apparatus 100 according to the first exemplary embodiment in that step S105 for acquiring the cell identification information les with respect to the coordinate values of a Raman spectral image based on a morphological image is included before step S110.

For a morphological image, a known microscopic observation method for acquiring secondary light that is linear with respect to primary light can be adopted. Known microscopic observation methods include optical arrangement, wavelengths of primary light and secondary light, a transmitted light image, and an incident light image.

### <Cell Sorter Unit>

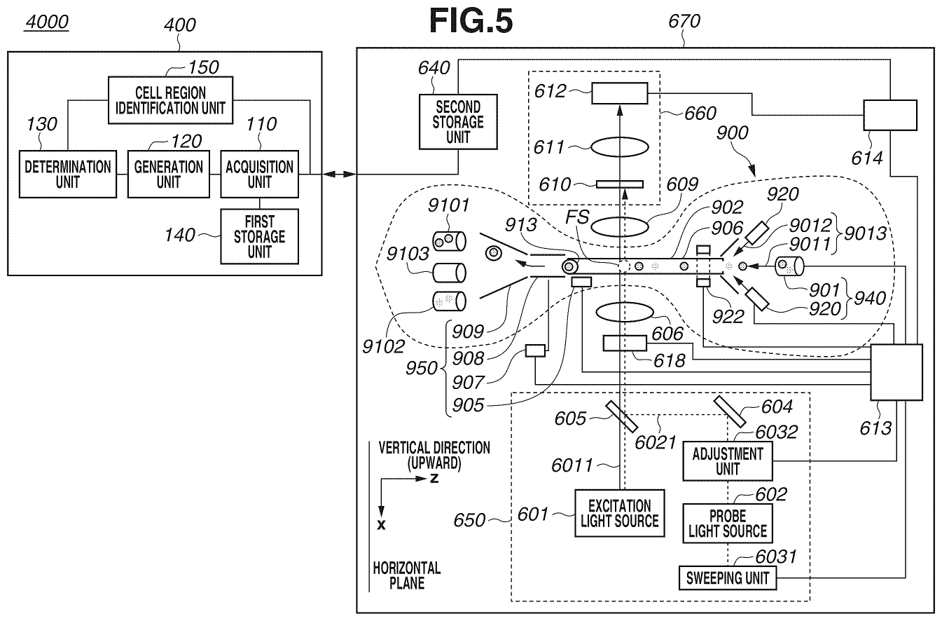

As illustrated in FIG. 5, a determination system 4000 according to a fourth exemplary embodiment is different from the determination system 1000 according to the first exemplary embodiment in that a cell sorter unit 900 is included that separates cells 906 in a cell suspension (fluid sample) 9013 into a living cell and a dead cell. An SRS microscope 670 according to the present exemplary embodiment comprises, as a part of the cell sorter unit 900, a flow path placement unit 902 that is configured such that the cell suspension 9013 passes through focal spots of the objective lens pairs 606 and 609 of the SRS microscope 670. At least a part of the flow path placement unit 902 has translucency that enables spectroscopically imaging.

### <Fluid Sample Supply Unit>

The cell sorter unit 900 comprises a sample container 901 that stores the cells 906 and a sheath fluid container 920 that stores a sheath fluid 9012 on an upstream side of the flow path placement unit 902.

The control unit 613 controls a flow rate of the cell suspension 9011 supplied from the sample container 901 and a flow rate of the sheath fluid 9012 supplied from the sheath fluid container 920 such that the cells 906 in the cell suspension 9011 flow through the flow path placement unit 902 by being aligned one cell at a time. The sample container 901, the sheath fluid container 920, and the control unit 613 configure a fluid sample supply unit 940 that supplies a fluid sample 9013 that is obtained by diluting the cell suspension 9011 with the sheath fluid 9012 and has fluidity. The sample container 901 and the sheath fluid container 920 that configure the fluid sample supply unit 940 are arranged on a side of a sample introducing inlet of the flow path placement unit 902. The fluid sample supply unit 940 is rephrased as a supply unit that supplies the fluid sample 9013 containing a plurality of biological cells to the flow path placement unit 902 on the upstream side of a focusing region FS in the flow path placement unit 902.

### <Passage Detection Unit>

The cell sorter unit 900 according to the present exemplary embodiment comprises, between the sample introducing inlet of the flow path placement unit 902 and a focal spot FS, a passage detection unit 922 that detects passage and flow speed of the cell 906. The passage detection unit 922 is also rephrased as a counter 922. The counter 922 is configured with electrostatic, optical, and acoustic sensors and the like. The control unit 613 controls timing of irradiating the primary light and collecting the secondary light using time tp and a time period Δtp at which the cell 906 passes through the focal spot FS that is predicted based on a monitoring result of the counter 922. The focal spot FS is rephrased as the focusing region FS in some cases.

### <Focal Spot>

The flow path placement unit 902 is arranged between the pair of objective lenses 606 and 609 such that the passing fluid sample 9013 passes through a region where the focal spots of the pair of objective lenses 606 and 609 overlap. Coherent light including the excitation light pulse train 6011 and the probe light pulse train 6021 is condensed through an objective lens 606 and irradiated as a primary light pulse on the cell 906 flowing in the flow path placement unit 902. The secondary light emitted from the cell 906 is substantially parallelized by the objective lens 609 and guided as collimated light toward the optical filter 610. The secondary light comprises a transmitted light component that is transmitted through the cell 906 and a scattered light component that is scattered by the cell 906. A process for detecting a Raman signal from the secondary light after passing through the optical filter 610 is similar to that of the SRS microscope 600 according to the first exemplary embodiment, the reconstruction unit 614, and a determination apparatus 400.

### <Fractionation Unit>

As illustrated in FIG. 5, the SRS microscope 670 according to the present exemplary embodiment further comprises a fractionation unit 950 that fractionates the cell 906 based on a determination result of the determination unit 130 on a downstream side of the focal spot FS in the flow path placement unit 902.

The fractionation unit 950 comprises a droplet forming unit 905 that ejects a droplet 913 containing the cell 906 from a sample outlet of the flow path placement unit 902. The droplet forming unit 905 is configured with a vibration unit such as a piezoelectric element that applies a vibration to the flow path placement unit 902. The droplet 913 is formed with the cell 906, a buffer solution, and the sheath fluid 9012. A concentration of cells contained in the cell suspension 9011 is adjusted in advance such that each droplet 913 contains one cell, and the control unit 613 controls flow speeds of the cell suspension 9011 and the sheath fluid 9012 in the flow path placement unit 902 and a vibration operation of the droplet forming unit 905. The droplet forming unit 905 is configured such that a plurality of droplets 913 is discharged from a discharge outlet of the flow path placement unit 902 at intervals.

The fractionation unit 950 comprises a charging plate 908 that charges the droplet 913 and a charge control unit 907 that controls a charge amount and a charge polarity of the droplet 913 with the charging plate 908. The charge control unit 907 controls the charge amount and the charge polarity based on a determination result by the determination apparatus 100 of the cell 906 corresponding to the droplet 913 that reaches the charging plate 908.

The fractionation unit 950 comprises an electrode pair 909 that applies an electrostatic field Fdc in a direction intersecting with a discharge direction near the discharge outlet of the droplet 913 to fractionate the droplet 913 with a predetermined charge. The droplet 913 with the predetermined charge is collected in each of predetermined collection containers 9101, 9102, and 9103 by the electrostatic field Fdc. According to the present exemplary embodiment, the droplets 913 determined as a living cell or a dead cell are respectively collected in the collection containers 9101 and 9102, and the droplet 913 determined in a boundary region travels straight ahead as the neutral droplet 913 without being charged and is collected in the collection container 9103.

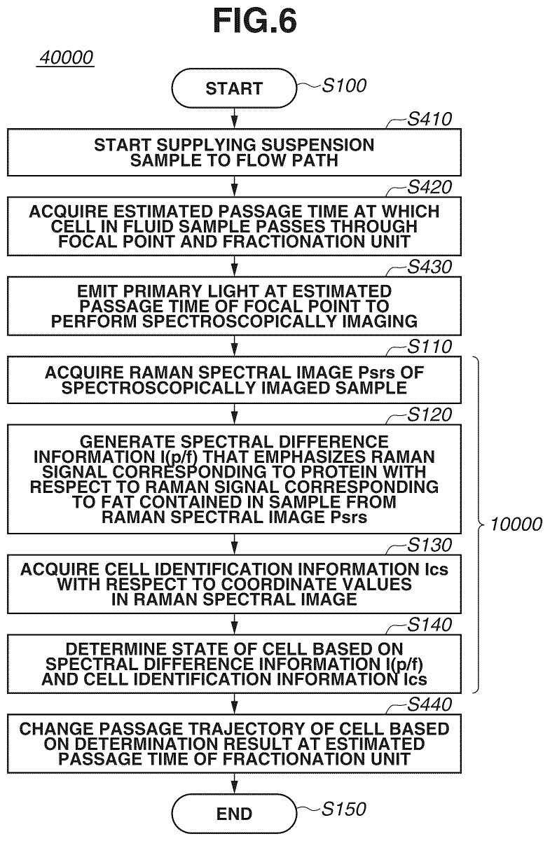

The determination system 4000 fractionates the cell suspension 9011 based on a control method 40000 illustrated in FIG. 6.

### <Starting Supply of Fluid Sample to Flow Path>

The control method 40000 comprises, following the start step S100, step S410 for starting supply of the fluid sample 9013 to the flow path placement unit 902.

<Acquiring Estimated Passage Time at which Cell in Fluid Sample Passes through Focal Spot and Fractionation Unit>

The control method 40000 comprises, following the supply start step S410, step S420 for acquiring an estimated passage time at which the cell 906 in the fluid sample 9013 passes through the focal spot FS and the fractionation unit 950. As the estimated passage time of passing through the fractionation unit 950, the estimated passage times of respectively passing through the droplet forming unit 905, the charging plate 908, and the electrode pair 909 are acquired.

### <Emitting Primary Light at Estimated Passage Time Passing Through Focal Spot to Perform Spectroscopically Imaging>

The control method 40000 comprises, following the estimated passage time acquisition step S420, step S430 for emitting the primary light at the estimated passage time of the focal spot FS to perform spectroscopically imaging. In step S430, the primary light is emitted at the estimated time when the cell 906 passes through the focal spot FS, and the spectroscopically imaging is performed.

### <Acquiring Raman Spectral Image Psrs of Sample Spectroscopically Imaged>

The control method 40000 comprises, following the spectroscopically imaging in step S430, step S110 for acquiring the Raman spectral image Psrs of the cell 906 that is spectroscopically imaged.

<Generating Spectral Difference Information I(p/f) Emphasizing Raman Signal Corresponding to Protein with Respect to Raman Signal Corresponding to Fat from Raman Spectral Image Psrs>

The control method 40000 comprises, following the spectral image acquisition step S110, step S120 for generating the spectral difference information I(p/f) that emphasizes the Raman signal corresponding to a protein with respect to the Raman signal corresponding to fat from the Raman spectral image Psrs.

<Acquiring Cell Identification Information Ics with respect to Coordinate Values in Raman Spectral Image>

The control method 40000 comprises, following the spectral difference information generation step S120, step S130 for acquiring the cell identification information Ics with respect to the coordinate values in the Raman spectral image.

### <Determining State of Cell Based on Spectral Difference Information I(p/f) and Cell Identification Information Ics>

The control method 40000 comprises, following the cell identification information acquisition step S130, step S140 for determining the state of the cell based on the spectral difference information I(p/f) and the cell identification information Ics.

Each of steps S110, S120, S130, and S140 corresponds to that in the control method 10000 of the determination system 1000 according to the first exemplary embodiment.

<Changing Ejection Trajectory of Droplet Passed through Fractionation Unit>

The control method 40000 comprises, following the cell state determination step S140, step S440 for changing an ejection trajectory of the droplet 913 that has passed through the fractionation unit 950, and following the ejection trajectory change step S440, the processing proceeds to end step S150.

According to the present exemplary embodiment, an operation of fractionating a living cell and a dead cell using the cell sorter unit 900 is described, but the state of the cell to be fractionated is not limited to a living cell and a dead cell. Further, a function of fractionating cells is mainly described, but a device can also be used serving as a flow cytometer that analyzes and statistically displays spectra of individual cells.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-153714, filed Sep. 6, 2024, which is hereby incorporated by reference herein in its entirety.

What is claimed is:

1. A determination apparatus comprising:
an acquisition unit configured to acquire a Raman spectral image captured by an image capturing apparatus configured to capture stimulated Raman scattering light from a biological cell irradiated with coherent primary light;
a generation unit configured to generate spectral difference information for emphasizing a Raman scattering light signal corresponding to one of different wavenumber shift bands of the Raman spectral image with respect to a Raman scattering light signal corresponding to the other of the different wavenumber shift bands;
a cell region identification unit configured to acquire cell identification information that identifies a cell region in a field of view of the Raman spectral image; and
a determination unit configured to determine a state of the cell based on the spectral difference information and the cell identification information.

2. The determination apparatus according to claim 1, wherein the different wavenumber shift bands correspond to (i) a wavenumber shift band corresponding to a protein and (ii) a wavenumber shift band corresponding to fat;
wherein, the different wavenumber shift bands do not overlap with each other.

3. The determination apparatus according to claim 2, wherein the wavenumber shift band corresponding to fat is included in a wavenumber shift band of 2800 cm⁻¹ or more and 2900 cm⁻¹ or less, and the wavenumber shift band corresponding to protein is included in a wavenumber shift band of 2920 cm⁻¹ or more and 2940 cm⁻¹ or less.

4. The determination apparatus according to claim 1, wherein the Raman spectral image comprises information about coordinate values in the field of view, information about a wavenumber shift value included in the wavenumber shift band, and information about intensity of a Raman scattering light signal corresponding to the wavenumber shift value.

5. The determination apparatus according to claim 1, wherein the spectral difference information comprises information about coordinate values in the field of view, and difference value information corresponding to a difference value between the one Raman scattering light signal and the other Raman scattering light signal.

6. The determination apparatus according to claim 1, wherein the state of the cell comprises at least one of activity, live or dead state, cause of death, and pharmacological effect of the cell.

7. The determination apparatus according to claim 1, wherein the cell identification information comprises information about coordinate values corresponding to a cell region in the Raman spectral image and information about a cell identification code corresponding to the cell region.

8. The determination apparatus according to claim 1, wherein the determination unit determines the state of the cell based on a result of comparing a predetermined reference value with the spectral difference information.

9. The determination apparatus according to claim 8, further comprising a first storage unit configured to store the predetermined reference value.

10. The determination apparatus according to claim 1, further comprising the image capturing apparatus.

11. The determination apparatus according to claim 10, wherein the acquisition unit acquires the Raman spectral image by reading the Raman spectral image from a second storage unit configured to store a plurality of Raman spectral images captured by the image capturing apparatus.

12. The determination apparatus according to claim 9, wherein the image capturing apparatus comprises:
a placement unit configured to place a sample containing the biological cell thereon,
a pair of objective lenses configured to face each other across the placement unit such that at least a part of a focal spot overlaps with the sample,
an irradiation optical system configured to irradiate the sample with coherent primary light through one of the pair of objective lenses, and
a detection optical system configured to detect a part of secondary light emitted from the sample by a nonlinear optical effect through the other of the pair of objective lenses.

13. The determination apparatus according to claim 12, wherein the irradiation optical system comprises an excitation light source configured to emit an excitation light pulse train and a probe light source configured to emit a probe light pulse train.

14. The determination apparatus according to claim 13, wherein the irradiation optical system comprises:
an adjustment unit configured to adjust a time difference between one of the excitation light pulse train and the probe light pulse train and the other,
a sweeping unit configured to sweep a wavelength of the coherent primary light to be emitted, and
a multiplexing unit configured to be optically coupled to the one of the objective lenses and multiplex the excitation light pulse train and the probe light pulse train.

15. The determination apparatus according to claim 14, further comprising:
a scanning unit configured to change a relative position of the sample with respect to the focal spot; and
a control unit configured to control the scanning unit, the sweeping unit, the excitation light source, and the probe light source in cooperation with each other.

16. The determination apparatus according to claim 15, wherein the detection optical system comprises:
an optical filter configured to selectively transmit a wavelength component of the excitation light or the wavelength component of the probe light from the secondary light collected through the other objective lens,
a condenser lens configured to condense transmitted light transmitted through the optical filter, and
a detection unit configured to detect a part of the secondary light guided through the optical filter and the condenser lens.

17. The determination apparatus according to claim 16, further comprising a reconstruction unit configured to generate the Raman spectral image by reconstructing an image based on a position of the focal spot and a detection signal output from the detection unit.

18. The determination apparatus according to claim 12, wherein the placement unit is configured with a flow path at least a part of which is transparent such that the sample having fluidity passes through the focal spot.

19. The determination apparatus according to claim 18, further comprising a fractionation unit configured to fractionate the sample based on a determination result of the determination unit on a downstream side of the focal spot in the flow path.

20. The determination apparatus according to claim 19, wherein the fractionation unit comprises a droplet forming unit configured to form a plurality of droplets that is ejected at intervals from at least a part of a fluid.

21. The determination apparatus according to claim 20, further comprising a supply unit configured to supply the fluid containing a plurality of the biological cells to the flow path on an upstream side of the focal spot in the flow path.

22. A method for controlling a determination apparatus that comprises an acquisition unit configured to acquire a Raman spectral image, a generation unit configured to generate spectral difference information that emphasizes a Raman signal of a first component with respect to a Raman signal of a second component, a cell region identification unit configured to identify a cell region, and a determination unit configured to determine a state of a cell contained in a sample, the method comprising:
acquiring the Raman spectral image with respect to a spectroscopically imaged sample using the acquisition unit;
generating spectral difference information that emphasizes a Raman signal corresponding to a protein with respect to a Raman signal corresponding to fat contained in the sample from the Raman spectral image using the generation unit;
acquiring cell identification information that identifies a cell region in a field of view of the Raman spectral image using the cell region identification unit; and
determining a state of the cell based on the spectral difference information and the cell identification information using the determination unit.

23. The method according to claim 22, wherein the determination unit is operated to determine a state of the cell based on a result of comparing a predetermined reference value with the spectral difference information.
